(19) United States
(12) Patent Application Publication
(10) Pub. No.: US 2026/0071996 A1
(43) Pub. Date: Mar. 12, 2026

(54) SAMPLING SYSTEM, DETECTION APPARATUS, AND METHODS OF USE THEREOF

(71) Applicant: SMITHS DETECTION-WATFORD LIMITED, Hemel Hempstead (GB)

(72) Inventors: Alastair CLARK, Hemel Hempstead (GB); Andrew Michael Bogan HOBSON, Hemel Hempstead (GB); Luca MARMUGI, Hemel Hempstead (GB)

(21) Appl. No.: 19/104,496

(22) PCT Filed: Aug. 21, 2023
(86) PCT No.: PCT/GB2023/052177

§ 371 Date: Feb. 18, 2025

(30) Foreign Application Priority Data
Aug. 19, 2022 (GB) 2212102.4

(51) Int. Cl. G01N 27/622; G01N 1/00; G01N 1/22; G01N 1/44; G01N 21/65

(52) U.S. Cl. CPC G01N 27/622; G01N 1/2214; G01N 1/44; G01N 21/658; G01N 2001/002; G01N 2201/126

(57) ABSTRACT

A sampling system for a detection apparatus, the detection apparatus comprising: (i) an ion analyser having an ioniser, 2024/038288 and (ii) an optical analyser for detecting substances of interest on a sample receiving surface, the sampling system comprising: a detector inlet for obtaining a volume of air to be sampled; an ion analyser sampling inlet arranged in the detector inlet to take a first sample from the volume of air in the detector inlet and to provide the first sample to the ioniser, and a sample receiving surface arranged in the detector inlet to receive a second sample from the volume of air in the detector inlet for optical analysis thereof.

WO

### TECHNICAL FIELD

The present disclosure relates to the field of detection apparatuses and methods. For example, the present disclosure relates to a sampling system for a detection apparatus, as well as a detection apparatus including such a sampling system. The present disclosure also includes methods of operating such sampling systems and/or detection apparatuses.

### BACKGROUND

There are numerous different spectrometry-related techniques for identifying the presence of a substance of interest in a given sample. Implementations of these techniques may be used for detecting the presence of chemical warfare agents (‘CWA’) or toxic industrial chemicals (‘TIC’), or any other chemical of interest, including, for example, explosives and their precursors. For such implementations, different sampling methods are typically implemented. In some cases, dedicated vapour sampling (‘vapour sniffing mode’) is realised. In other cases, a sample is typically provided on some form of substrate. The substrate and sample are then heated to desorb the sample from the substrate in the form of a vapour. This vapour is then passed to a detector which measures properties of this vapour and detects the presence of a substance of interest on the basis of these measurements. For example, in an ion mobility spectrometer (‘IMS’) or in a mass spectrometer (‘MS’), ionised molecules may be identified based on their mobility in a carrier buffer gas or air, or based on other properties. Detection devices are known which utilise these techniques for detecting the presence of hazardous or illegal materials, such as CWAs and TICs.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided a sampling system for a detection apparatus, the detection apparatus comprising: (i) an ion analyser having an ioniser, and (ii) an optical analyser (e.g. a surface-enhanced Raman spectroscopy, SERS, analyser) for detecting substances of interest on a sample receiving surface (e.g. a SERS-active surface), the sampling system comprising: a detector inlet for obtaining a volume of air to be sampled; an ion analyser sampling inlet arranged in the detector inlet to take a first sample from the volume of air in the detector inlet and to provide the first sample to the ioniser; and a sample receiving surface (e.g. a SERS-active surface) arranged in the detector inlet to receive a second sample from the volume of air in the detector inlet for optical (e.g. SERS) analysis thereof.

Embodiments may enable increased reliability for the detection of a substance of interest. For example, detecting the presence of the substance of interest using both an ion analyser having an ioniser and an optical (e.g. SERS) analyser may enable the presence or absence of potentially ambiguous substances to be confirmed or denied based on data from both analysers. For example, a positive result from the ion analyser may be confirmed or denied using the optical analyser, or a positive result from the optical analyser may be confirmed or denied using the ion analyser. In other words, embodiments may enable optically active detection (e.g. SERS detection) in conjunction with ion analyser detection (e.g. ion mobility spectrometry or mass spectrometry). For example, this may enable orthogonal detection to be provided.

The optical analyser may be a surface-enhanced Raman spectroscopy, SERS, analyser for detecting substances of interest on a SERS-active sample receiving surface. The sample receiving surface may be an optically active sample receiving surface for facilitating optical analysis thereof. The sample receiving surface of the sampling system may be a SERS-active surface arranged to receive the second sample for SERS analysis thereof.

The sample receiving surface (e.g. a SERS-active surface) may be arranged downstream of the ion analyser sampling inlet in the direction of air flow through the detector inlet. For example, the sampling system may include an air mover configured to provide flow of air through the sampling system (e.g. from an upstream location towards a downstream location). The sample receiving surface (e.g. the SERS-active surface) may be arranged so that the air flow through the detector inlet strikes the sample receiving surface (e.g. the SERS-active surface). The sample receiving surface (e.g. the SERS-active surface) may be arranged across the direction of air flow through the detector inlet and/or it may be arranged to be parallel to the direction of air flow through the detector inlet. The surface may be gas permeable, or it may be a solid, non-gas permeable surface. The system may be arranged so that air flowing through the detector inlet is forced through the sample receiving surface (e.g. the SERS-active surface) to deposit the second sample on the sample receiving surface (e.g. the SERS-active surface). The sample receiving surface (e.g. the SERS-active surface) may be arranged to obstruct air passing through the detector inlet. The sampling inlet may be arranged upstream of the sample receiving surface (e.g. the SERS-active surface), so that some of the air which has passed (and not been drawn into) the sampling inlet will be directed towards, and obstructed by, the sample receiving surface (e.g. the SERS-active surface). In other examples, the sample receiving surface may be located in the same region as the ion analyser sampling inlet or upstream of the ion analyser sampling inlet.

The detector inlet may comprise a housing, such as a body, which defines a channel through which a gaseous sample may flow. The detector inlet may channel the gaseous sample to flow in a downstream direction. Some of this sample may be drawn in through the detector inlet. The rest of this sample may travel further downstream (e.g. towards the sample receiving surface). A first portion of this gaseous sample (e.g. a first sample) may be drawn into the ion analyser (e.g. towards the IMS) for analysis thereof by the ion analyser. A second portion of this gaseous sample (e.g. a second sample) may contact, and be received on, the sample receiving surface (e.g. the SERS-active surface) for optical (e.g. SERS) analysis thereof. In other words, the sampling inlet comprises a portion of the detector inlet for drawing in some gas from the detector inlet to be taken towards the ion analyser. The sample receiving surface (e.g. the SERS-active surface) is provided within the detector inlet for receiving a sample passing through that region (e.g. for optical analysis thereof). The first sample may be obtained, before, simultaneously to, or after, the second sample is obtained. One of the first or second sample may only be analysed in the event that analysis of the other of the first and second sample indicates that a substance of interest may be present. The sample may be a gas. The sample may comprise a vaporised aerosol (e.g. aerosol vapour).

A portion of the detector inlet may be arranged to enable optical (e.g. SERS) measurements to be obtained from the sample receiving surface (e.g. the SERS-active surface). Said portion of the detector inlet may be arranged to provide one or more light sources and/or one or more optical detectors with optical access to the sample receiving surface. For example, the light source may comprise a Raman light source, and the light detector may comprise a Raman detector. The Raman source and detector may be arranged in a reflective mode, e.g. with the Raman detector arranged to detect relevant light associated with reflection off the SERS-active surface. The portion of the detector inlet may comprise one or more apertures in the detector inlet. The system may comprise a heater for heating the sample receiving surface (e.g. the SERS-active surface). The heater may be operable to drive off accumulated material from the surface. For example, the heater may be controlled to turn on and start heating to drive off a sample which has been analysed. The heater may then be controlled to turn off to enable a subsequent measurement to be performed for the surface. The ion analyser sampling inlet may comprise a pinhole inlet. The sampling system may be for an ion analyser comprising an ion mobility spectrometer, IMS or a mass spectrometer, MS. As set out above, the optical analyser may comprise a SERS analyser. Additionally, or alternatively, the system may comprise any suitable type of optical analyser, and/or any type of surface enhanced spectroscopic analysis approach. Example optical analysis approaches include use of an infrared, IR, analyser. The optical analyser, e.g. the IR analyser, may comprise a transmission (e.g. where light passes through the substrate) or reflection (e.g. where light reflects from the substrate) based analyser. For example, a cross flow IR analyser may be used.

In an aspect, there is provided a detection apparatus for detecting substances of interest, the apparatus comprising: a sampling system as disclosed herein; an ion analyser having an ioniser, wherein the ion analyser is coupled to the sampling system and arranged to identify the presence of one or more substances of interest in the first sample provided to the ion analyser through the ion analyser sampling inlet of the sampling system; and an optical analyser (e.g. a SERS analyser) coupled to the sampling system and arranged to identify the presence of one or more substances of interest in the second sample received by the sample receiving surface (e.g. the SERS-active surface) of the sampling system.

The ion analyser may comprise an IMS or MS. The apparatus may comprise a thermal desorber (e.g. a thermal desorption module) for generating a vapour sample to be provided as the sample to the detector inlet. For example, the thermal desorber may be arranged upstream of the detection inlet to generate a gaseous sample to be provided to the detector inlet.

The apparatus may be arranged so that the first and second sample are provided from the same volume of air flowing through the detector inlet of the sampling system. The apparatus may be configured to selectively control operation of the two analysers. For example, the apparatus may be configured to first perform analysis using one of the analysers, before subsequently performing analysis with the other analyser. The apparatus may be configured so that one of the analysers is only used in the event that the other analyser detects a substance of interest. For example, one of the analysers may be used only as a confirmational analyser-e.g. to either confirm or deny the results obtained by the other analyser.

The apparatus may be configured to selectively control operation of at least one of: (i) the optical (e.g. SERS) analyser based on operation of the ion analyser, and/or (ii) the ion analyser based on operation of the optical (e.g. SERS) analyser. The apparatus may be configured to determine that a substance of interest is present in the air from the detector inlet of the sampling system based on analysis performed by both the ion analyser and the optical (e.g. SERS) analyser. The apparatus may be configured to identify that the substance of interest is present in the air from the detector inlet of the sampling system in the event that both: (i) the analysis performed by the ion analyser, and (ii) the analysis performed by the optical (e.g. SERS) analyser indicate that the substance of interest is present. The apparatus may be configured to determine that the substance of interest is not present in the event that at least one of: (i) the analysis performed by the ion analyser, or (ii) the analysis performed by the optical (e.g. SERS) analyser indicates that the substance of interest is not present. For example, the apparatus may be configured to determine that the substance of interest is not present in the event that one of the analysers indicates that the substance is present, but the other analyser indicates that it is not present.

The apparatus may be configured to control operation of the ion analyser to identify the presence of one or more substances of interest in the first sample, and in the event that a substance of interest is identified in the first sample using the ion analyser, the apparatus may be configured to control operation of the optical (e.g. SERS) analyser to identify the presence of that substance of interest in the second sample. The apparatus may be configured to control operation of the optical (e.g. SERS) analyser to identify the presence of one or more substances of interest in the second sample, and in the event that a substance of interest is identified in the second sample using the optical (e.g. SERS) analyser, the apparatus may be configured to control operation of the ion analyser to identify the presence of that substance of interest in the first sample. The apparatus may be configured to initially use only one active analyser. The apparatus may be configured only to use the second analyser in the event that the first analyser indicates that a substance of interest may be present. For example, the apparatus may be configured to perform optical (e.g. SERS) analysis of second samples until one of those second samples contains a substance of interest. In the event that the optical (e.g. SERS) analysis indicates the presence of the substance of interest, then the apparatus may be configured to perform the ion analysis (e.g. to then use an IMS or MS to analyse that sample).

Operation of the second analyser may be controlled based on the results from the first analyser. For example, in the event that the first analyser indicates a first substance of interest is present, the second analyser may be operated based on that first substance. For example, the analysers may have different operation configurations, and the particular operation configuration may be selected based on the first substance to be identified. For example, a particular ion analyser detection configuration (e.g. detection algorithm) may be used based on the first substance detected by the optical (e.g. SERS) analyser.

The apparatus may be configured to provide an output signal indicative of material of interest detected. The output signal may contain an indication of which one of the analysers indicated that the material of interest was present, or an indication that both analysers indicated that the material of interest was present. For example, the output signal may provide a confidence score relating to how likely the output is correct based on whether only one, or both, of the analysers found that material of interest to be present in the sample.

In an aspect, there is provided a method of controlling operation of a sampling system for a detection apparatus, the detection apparatus comprising: (i) an ion analyser having an ioniser, and (ii) an optical analyser (e.g. a surface-enhanced Raman spectroscopy, SERS, analyser) for detecting substances of interest on a sample receiving surface (e.g. a SERS-active surface), wherein the method comprises: flowing air through a detector inlet of the sampling system; taking a first sample from the detector inlet and providing said first sample to an ioniser of an ion analyser; and receiving a second sample from the detector inlet on a sample receiving surface (e.g. SERS active surface) in the detector inlet.

In an aspect, there is provided a method of controlling operation of a detection apparatus to identify the presence of one or more substances of interest in a volume of air flowing through a detector inlet of a sampling system of the detection apparatus, the method comprising at least one of: (i) operating an ion analyser to identify the presence of one or more substances of interest in a first sample taken from the detector inlet, and in the event that the ion analyser identifies the presence of one or more substances of interest in the first sample, operating an optical (e.g. surface-enhanced Raman spectroscopy, SERS) analyser to identify the presence of said one or more substances of interest in a second sample received on a sample receiving surface (e.g. a SERS-active surface) in the detector inlet, and (ii) operating an optical (e.g. SERS) analyser to identify the presence of one or more substances of interest in a second sample received on a sample receiving surface (e.g. SERS-active surface) in the detector inlet, and in the event that the optical analyser identifies the presence of one or more substances of interest in the second sample, operating an ion analyser to identify the presence of said one or more substances of interest in a first sample taken from the detector inlet.

In an aspect, there is provided a method of detecting the presence of a substance of interest in a volume of air flowing through a detector inlet of a sampling system, the method comprising: determining whether a first substance of interest is present in a first sample taken from the detector inlet based on ion analyser data from ion analysis of the first sample; determining whether the first substance of interest is present in a second sample received on a sample receiving surface (e.g. a SERS-active surface) in the detector inlet based on optical (e.g. SERS) analyser data from optical (e.g. SERS) analysis of the second sample; and indicating that the first substance of interest is present in the event that it is determined that the first substance of interest is present in both the ion analyser data and the optical (e.g. SERS) analyser data.

Aspects of the present disclosure provide one or more computer program products comprising computer program instructions configured to program a controller to control operation of a device to perform any of the methods disclosed herein. For example, the computer program instructions may be configured to control operation of a detection apparatus to perform sample analysis using an ion analyser, such as an IMS or an MS, and an optical analyser, such as a SERS analyser or an IR analyser, as disclosed herein.

### FIGURES

Some examples of the present disclosure will now be described, by way of example only, with reference to the figures, in which:

FIG. 1 is a schematic diagram of a sampling system.

FIG. 2 is a schematic diagram of a detector.

In the drawings like reference numerals are used to indicate like elements.

### SPECIFIC DESCRIPTION

The present disclosure relates to systems and methods which may utilise optical analysis, such as Surface Enhanced Raman Spectroscopy (‘SERS’), in combination with an additional detection technology. For this, a sample to be analysed may be split so that one portion of that sample is analysed using a SERS analyser and another portion of that sample is analysed using a different analysis technology, such as using an lon Mobility Spectrometer (‘IMS’). The two different detection approaches may be used in combination to increase the reliability of detection for that sample. The present disclosure includes a sampling system for providing separate detection streams: (i) one for the SERS detection, and (ii) one for the different (e.g. IMS) detection. The sampling system may receive the sample through a detector inlet, and that sample may flow through the sampling system. A portion of that sample may flow through an ion analyser sampling inlet in the sampling system to a detector where that portion of the sample will be analysed. Another portion of that sample may flow onto a SERS-active surface, where that portion of the sample may be SERS analysed. The SERS-active surface may obstruct a flow path through the sampling inlet (e.g. downstream of the ion analyser sampling inlet) so that at least some of the sample which does not flow to the detector has to pass through the SERS surface, thereby leading to some of the sample being deposited on the SERS surface.

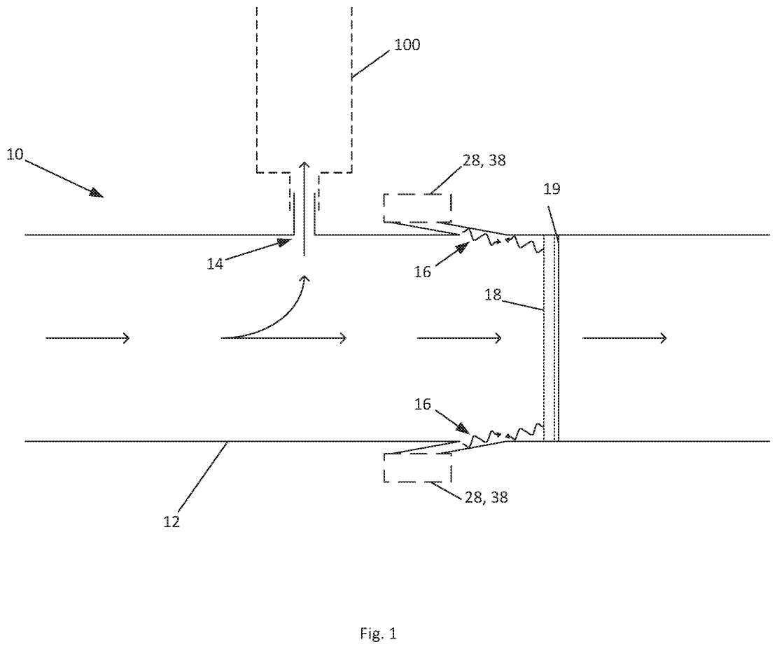

One example of a sampling system will now be described with reference to FIG. 1.

FIG. 1 shows a sampling system 10. The sampling system 10 includes a detector inlet for obtaining a volume of air to be sampled. The sampling system 10 is formed of a body 12. The sampling system 10 also includes a sampling inlet 14 and a sample receiving surface for receiving a sample to be optically analysed. In the example of FIG. 1, the sample receiving surface is a Surface Enhanced Raman Spectroscopy (‘SERS’) active surface 18 (i.e. a SERS-active surface to be SERS analysed). A detector 100 is shown connected to the sampling inlet 14. An optional heater 19 is also shown in FIG. 1. The lines through the body 12 show the direction of flow for the volume of air to be sampled.

The sampling system 10 may also include a plurality of optical apertures 16. One or more light sources 28 are shown, as are one or more light detectors 38. In FIG. 1, the sources 28 and detectors 38 are shown by the same component. For example, each source 28-detector 38 pair may be arranged in a reflective configuration (where the detector 38 is for detecting reflected emissions of light). The sinusoidal lines show photons of light (to help show the path for light between the light sources 28 and the light detectors 38). The detector 100 and the light sources 28 and light detectors 38 are shown in dashed lines, as they may be provided by separate components to those of the sampling system 10.

The body 12 of the sampling system 10 provides a housing through which gas will flow. The body 12 defines a channel through which gas flows through the sampling system 10. The sampling system 10 may comprise an air mover, such as a pump or a fan. The air mover may control movement of air through the sampling system 10. The air mover may operate to flow air through the body 12 (e.g. as indicated by the arrows in FIG. 1).

The sampling inlet 14 is provided in the body 12. For example, the sampling inlet 14 may comprise a pinhole inlet. The pinhole inlet may be provided in the body 12. The sampling inlet 14 may optionally include a membrane (for selectively controlling flow of air towards the detector 100). The detector 100 is connected to the sampling inlet 14.

The SERS surface 18 is provided in the body 12 (in the channel defined by the body 12 through which gas flows). As shown in FIG. 1, the SERS surface 18 is located downstream of the sampling inlet 14. In other examples, the SERS surface 18 may be located upstream, or at, the sampling inlet 14. In each example, SERS analysis is provided in parallel with the ion analyser (e.g. so that different portions of the same sample are analysed in different ways). For example, the SERS analysis could be performed as a pre-filter to performing ion analyser analysis. As can be seen by the arrows in FIG. 1, the gas will flow through the body 12 (from left to right). For example, the air mover of the sampling system 10 may be located to provide such controlled flow of gas through the body.

The sampling system 10 is arranged to divert some of the gas flowing through the body 12 towards the detector 100. For example, the detector 100 may include a suction element configured to draw air from the channel inside the body 12 through the sampling inlet 14 towards the detector. The sampling inlet 14 may include a pinhole inlet and/or a membrane covering, e.g. to inhibit unintended flow of gas through the sampling inlet 14. In other words, the sampling system 10 may be configured to selectively, actively draw gas through the sampling inlet 14 (e.g. when the gas is to be sampled by the detector 100).

The gas moving through the channel of the body 12 which is not drawn into the sampling inlet 14 will continue to flow downstream of the sampling inlet (e.g. as controlled by the air mover). The sampling system 10 is arranged so that some of the air which flows downstream of the sampling inlet 14 will be provided to the SERS surface 18.

The channel of the body 12 may provide a detector inlet. The channel of the body 12 (e.g. the detector inlet) may be arranged to receive a sample to be analysed. The sample may comprise a gas, such as gas that has been desorbed from a swab (or any other suitable such sample collecting means). Additionally, or alternatively, the sample may comprise an aerosol (e.g. a vaporised aerosol). For example, devices of the present disclosure may be configured to convert an aerosol into a vapour (e.g. using a heater), e.g. where that vapour could be provided as the sample to be analysed. The sampling system 10 is arranged so that some of the air flowing through the channel of the body 12 (e.g. as provided from the sample to be analysed) will be delivered to the detector 100 (through the sampling inlet 14), and some of the air flowing through the channel of the body will be delivered to the SERS surface 18. The air mover may be arranged to control flow of air from where that air is received into the detector inlet from the sample (e.g. from a thermal desorption module) and then through the channel of the body 12 towards the analysers. The sampling system is operable to extract some of that air through the sampling inlet 14 (e.g. by providing suction in that region), and to deliver some of that air to the SERS surface (e.g. as the air continues to flow through the channel of the body 12 past the sampling inlet 14).

The SERS surface 18 may be arranged across the channel of the body 12 (as shown in FIG. 1). The SERS surface 18 may extend across a majority of the width of the channel. For example, the SERS surface 18 may obstruct a majority of the cross-sectional area of the channel. The SERS surface 18 may extend across the channel to obstruct the flow of the gas through the channel. For example, the SERS surface 18 may be substantially perpendicular (e.g. perpendicular) to the direction of flow through the channel (e.g. perpendicular to a longitudinal axis of the body 12). The SERS surface 18 may be at least partially gas-permeable, or the surface 18 may be provided by a solid (e.g. non-permeable) substrate.

It will however be appreciated that the SERS surface 18 could be provided in additional or alternative configurations. For example, the SERS surface 18 may lie parallel to the direction of air flow through the channel. The SERS surface 18 may be arranged so that, as air containing the sample substance is moved through the channel, at least some of that sample substance may be provided on the SERS surface 18.

The heater 19 may be located adjacent to the SERS surface 18. It will be appreciated that any suitable heater may be provided, such as a resistance heater (as shown in FIG. 1) or alternative heating mechanisms such as an infrared heater. Where a resistance heater is used, the heater 19 may include one or more portions of material having sufficient electrical resistance to generate heat in response to current flowing therethrough. Such conductors may be connected to the SERS surface 18, e.g. they may be electrically connected to a least a portion of the SERS surface 18. The optical apertures 16 may comprise optically transparent regions of the body 12. For example, the optical apertures 16 may be apertures in the body 12 (e.g. regions without any material present), or they may be regions of material in the body 12 which are optically transparent. The optical apertures 16 may be located in close proximity to the SERS surface 18. The optical apertures 16 may be located both upstream and downstream of the SERS surface 18, or they may only be located on one side of the SERS surface 18 (as shown in FIG. 1). The sampling system 10 may have optical apertures 16 for one or more (e.g. a plurality of) light sources 28. The sampling system 10 may have optical apertures 16 for one or more (e.g. a plurality of) light detectors 38.

In the example shown in FIG. 1, the optical apertures 16 (both light sources 28 and detectors 38) are upstream of the SERS surface 18. However, it will be appreciated that this is not intended to be limiting. The light sources 28 and/or detectors 38 could be provided on either or both sides of the SERS surface 18. For example, both the light sources 28 and the light detectors 38 could be provided on the same side of the SERS surface 18. The light sources 28 and detectors 38 are arranged to be provided in close enough proximity to the SERS surface 18 so that they may be used to perform SERS analysis on a sample on that surface 18.

In the example of FIG. 1, the sample receiving surface is a SERS surface 18. However, it is to be appreciated that other forms of optical analysis could be used. For example, an infrared analyser may be provided for optically analysing the sample receiving surface. For a SERS surface 18, the light sources 28 and detectors 38 may be provided in a reflective arrangement (e.g. for the detectors 38 to detect reflected light from the light sources 28). For an infrared surface, the light sources 28 and detectors 38 may be provided in a transmissive arrangement (e.g. with the detectors 38 on the opposite side of the surface to the light sources 28).

The sampling system 10 is arranged to receive a gaseous substance to be sampled. Although not shown, a gas sample receiving region may be located upstream of the portion of the sampling system 10 shown in FIG. 1. That is, the sampling system 10 may include an intake region where a gaseous sample is drawn into the sampling system 10, such as from a swab. The sampling system 10 is arranged to provide a flow through configuration. The sampling system 10 is arranged for a gaseous sample to be provided as an input to the sampling system 10 and to flow through the sampling system 10. The air mover may be arranged to operate to provide this flow of sample through the channel of the body 12. For example, the air mover is configured to direct the gaseous sample downstream from an upstream location (e.g. where the gaseous sample is received, such as from a swab). The air mover is configured to control the gaseous sample to flow downstream towards the sampling inlet 14 (and also towards the SERS surface 18). The sampling system 10 and/or the detector 100 may be arranged to draw at least some of the received gaseous sample through the sampling inlet 14 towards the detector 100. The air mover is configured to flow the sample through the channel so that at least some of the received gaseous sample will be provided on the SERS surface 18 in the channel.

The sampling system 10 may be arranged to provide analyte neutrals from the same sample to both the detector 100 (through the sampling inlet 14) and the SERS surface 18. The sampling system 10 is arranged to provide both: (i) a first portion of the gaseous sample to the detector 100 (through the sampling inlet 14), and (ii) a second portion of the same gaseous sample to the SERS surface 18. The sampling system 10 is arranged to facilitate parallel detection using the detector 100 (e.g. an IMS), and a SERS analyser (which analyses the sample provided on the SERS surface 18). In other words, the sampling system 10 is arranged to redistribute some portions of the same sample into one of two different regions where they can be analysed. The sampling system 10 is arranged with the sampling inlet 14 upstream of the SERS surface 18. The detector 100 (or an air mover of the sampling system 10) may be arranged to draw the portion of the sample which is to be analysed by the detector 100 from the flow path through the channel of the body 12 towards the detector 100 (through the sampling inlet 14). The sampling system 10 is configured to provide some of the remaining portion of the sample (which is to be SERS analysed) towards the SERS surface 18.

The body 12 may be arranged to define a fluid flow path for the gaseous sample. The body 12 may be arranged to constrain gaseous flow through the channel of the body 12 from upstream to downstream. The upstream portion of the body 12 may be arranged to receive the gaseous sample. The body 12 may be arranged to guide the gaseous sample towards the SERS surface 18. The sampling inlet 14 may be arranged in the body 12 upstream of the SERS surface 18. The sampling inlet 14 may be arranged to receive a portion of the gas flowing through the channel in the body 12 (e.g. a portion of the gas flowing through the channel in the body 12 may be actively drawn in through the sampling inlet 14, such as through a pinhole inlet). The sampling system 10 is configured to operate so that a portion of the gas which flows through the channel towards the SERS surface 18 is instead diverted through the sampling inlet 14 (towards the detector 100). The body 12 is arranged so that the remaining portion of the gas will flow towards the SERS surface 18, where some of the sample will be provided on the SERS surface 18 (and some will flow beyond the SERS surface 18, e.g. towards an outlet of the sampling system 10).

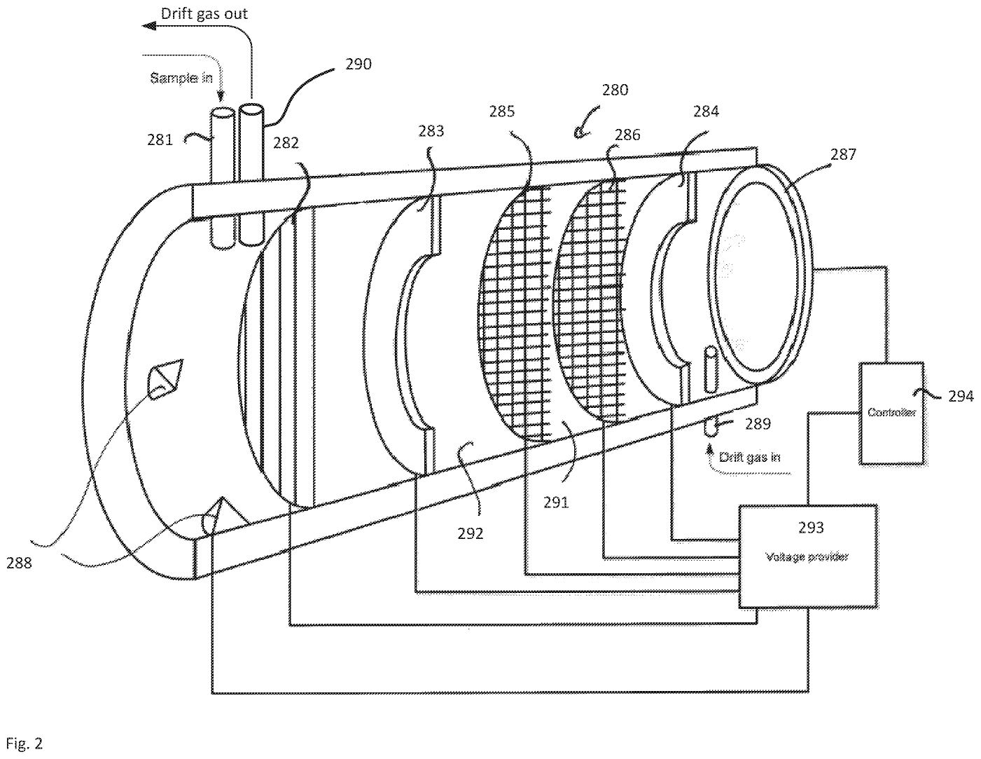

The detector 100 is configured to detect the presence of one or more substances of interest in the portion of the sample provided to the detector 100. The detector 100 includes an ion analyser having an ioniser. The ioniser is arranged to ionise the portion of the sample provided to the detector 100. The ion analyser is arranged to analyse those ions to detect the presence of the substance of interest in the sample. The detector 100 may be any suitable detector, such as a spectrometer e.g. a mass spectrometer, or an ion mobility spectrometer (‘IMS’). The detector 100 may be arranged to detect the presence of the substance of interest based on one or more properties of the sample, such as the mobility or the mass of the sample and/or of ions which were ionised from the sample. The detector 100 may be arranged to receive analyte neutrals through the sampling inlet 14. The detector 100 may be arranged to ionise those analyte neutrals, and to perform detection on the ionised sample. Conversely, the sample deposited on the SERS surface 18 may be analyte neutrals (e.g. which have not been ionised by an ioniser). One example of a detector 100 will be described in more detail below in relation to the IMS shown in FIG. 2.

The SERS surface 18 may be arranged to obstruct gas flowing through the channel from an upstream location towards a downstream location. For example, the SERS surface 18 may be arranged in the channel so that at least some of the gas sample flowing in the channel downstream of the sampling inlet 14 will be deposited on the SERS surface 18. The sampling system 10 may be arranged to force (a majority of) the gas sample to try to flow through the SERS surface 18. The SERS surface 18 may be arranged so that some of the gas may flow through it, but some of the gas will not, causing a portion of the sample to be provided on the SERS surface 18 (where it may be SERS analysed).

The light source(s) 28, light detector(s) 38 and SERS surface 18 may form a SERS analyser. The SERS analyser may be arranged to perform SERS analysis on any substances on the SERS surface 18. The SERS analyser may include one or more light sources 28 arranged to direct light towards the SERS surface 18. Each light source 28 may be located adjacent to an optical aperture 16 of the body 12, and with a line of sight at the SERS surface 18 in the channel. The light source 28 may comprise a laser. Each light detector 38 may be located adjacent to an optical aperture 16 of the body 12, and with a line of sight at the SERS surface 18 in the channel. The light detector 38 may be arranged to detect scattered light from the sample on the SERS surface 18. The SERS analyser may be configured to determine one or more properties of the sample based on wavelengths of scattered light received at the light detectors 28. The SERS analyser may be arranged to determine whether or not a substance of interest is present in the sample based on Raman scattered light from the sample (e.g. based on a wavelength of the Raman scattered light). The SERS analyser may be arranged in the sampling system 10 downstream of the sampling inlet 14 so that the portion of the sample to be (ionised and) analysed by the detector 100 is different to a portion of the same sample which is to be analysed by the SERS analyser. The detector 100 may be arranged to analyse analyte ions, and the SERS analyser may be arranged to analyse analyte neutrals.

The heater 19 may be selectively operable to heat the SERS surface 18. The heater 19 may comprise a resistive heater 19 arranged to generate heat in response to a voltage being applied to the heater 19. The heater 19 may be arranged to heat the SERS surface 18 to drive off accumulated material on the SERS surface 18 (e.g. sample which has previously been deposited on that surface). The heater 19 may be controlled to heat the SERS surface 18 prior to a subsequent SERS analysis being performed (e.g. after the SERS analyser has finished performing a previous SERS analysis on a sample on the SERS surface 18).

Although not shown in FIG. 1, the sampling system 10 may be provided in combination with a flow control system. The flow control system may include one or more air movers, such as a pump or fan (as described above). The flow control system may be arranged to provide the fluid flow dynamics described above for the sampling system 10 (e.g. so that the gaseous sample flows downstream through the sampling system 10). The sampling system 10 may comprise the flow control system, e.g. the sampling system 10 may include one or more air movers arranged to control the flow of air through the body 12 (e.g. the sampling system 10 may include one or more pumps). Additionally, or alternatively, the flow control system may be provided by an external device, such as a device located upstream and/or downstream of the sampling system 10, or the flow control system may be provided as part of the detector 100.

Embodiments of the present disclosure may provide a detection apparatus which includes the detector 100, the sampling system 10 and the SERS analyser as described above. Such a detection apparatus may also include a controller configured to control operation of the detection apparatus. The controller may be coupled to the detector 100 to control operation thereof, and/or to receive signals therefrom indicative of the presence of any substances of interest in a sample analysed by the detector 100. The controller may be coupled to the SERS analyser to control operation thereof, and/or to receive signals therefrom indicative of the presence of any substance of interest in a sample analysed by the SERS analyser. The controller may be coupled to the flow control system to selectively control the flow of gas through the sampling system 10.

The controller is configured to determine whether or not a substance of interest is present in a sample based on both: (i) analysis performed by the detector 100 on a first portion of the sample (e.g. which contains analyte ions), and (ii) SERS analysis performed by the SERS analyser on a second portion of the same sample (e.g. which contains analyte neutrals). The controller may be configured to confirm or deny the analysis performed by one of the analysers using the other analyser. For example, the SERS analysis may be used for confirming/denying IMS analysis, or vice versa. In one example, IMS usage may be limited by only using the IMS to perform analysis on a sample in the event that the SERS analysis indicates that a material of interest is present in that sample.

The controller may be arranged to confirm the presence of a substance of interest in the sample in the event that both the analysis from the detector 100 and the analysis from the SERS analyser indicate that the substance of interest is present in the sample. The controller may reduce the false alarm rate for the detector 100, e.g. the controller may be configured to only indicate that a substance of interest is present in the sample if both the detector 100 and the SERS analyser indicate that the substance of interest is present. For example, where two different substances have similar ion mobilities, the detector 100 may not be able to discern which of the two different substances is present. Use of the SERS analyser may however enable that determination to be performed (and likewise the IMS may be able to discern between two different substances which the SERS analyser might not).

The controller may be configured to determine that a material of interest is not present in the event that the detector 100 indicated that a substance of interest was present in the sample, but the SERS analyser indicated that it was not (or vice-versa). The controller may be configured to determine that the substance of interest is present in the sample in the event that both the detector 100 and the SERS analyser indicate the presence of the substance of interest.

The controller may be configured to selectively use one of the analysers based on the output from the other analyser. For example, the controller may be configured to only use the SERS analyser in the event that the detector 100 indicates that a substance of interest has been identified in the sample (e.g. in the event that the detector 100 has identified one or more substances in the sample which have similar properties to those of a substance of interest, such as ion mobility or mass properties), or vice versa (e.g. only using the IMS in the event that the SESR analyser indicates material of interest is present). For example, in the event that the controller obtains an indication that the detector 100 has identified such a substance of interest in the sample, the controller may control operation of the SERS analyser to perform SERS analysis on the substance received by the SERS surface 18 in the sampling system 10. The controller may determine that the substance of interest is present, or not, based on the subsequent SERS analysis performed on the sample. This approach may reduce the number of times the SERS analyser needs to be used. For example, the SERS analyser may be used only when the detector 100 indicates that a substance of interest may be present in the sample. The alternative ordering may also be provided, i.e. to reduce the number of times the IMS is used by only using the IMS when the SERS analyser indicates that a substance of interest is present.

The controller may be configured to control operation of the flow control system (e.g. of the one or more air movers) and/or the heater 19. The controller may be configured to control the flow control system to operate so that a gaseous sample flows through the sampling system 10 with a portion of that sample being drawn into the detector 100 through the sampling inlet 14, and a portion of that sample being provided on the SERS surface 18. The controller may be configured to control operation of the flow control system so that no new sample is delivered through the sampling system 10 until after it has been determined whether or not a substance of interest was present in the original sample. For example, the controller may control the flow control system to stop driving the flow of the sample through the sampling system 10 until it has been determined whether or not a substance of interest is present. Once the controller has determined whether or not a substance of interest is present in the sample (e.g. after an outcome from the detector 100, and an outcome from the SERS analyser, if needed), the controller may control operation of the heater 19 to heat the SERS surface 18 and to desorb any material from the SERS surface 18 (e.g. which may be driven downstream of the SERS surface 18). The controller may then control the flow control system to provide a new sample to the sampling system 10 for analysis by the detector 100 and potentially also the SERS analyser.

In operation, a flow of gaseous sample is provided through the channel in the body 12 of the sampling system 10. A first portion of this gaseous sample will be drawn in through the sampling inlet 14 to the detector 100. The detector 100 will ionise and ion analyse this first portion of the sample. A second portion of the same gaseous sample will be provided on the SERS surface 18 in the channel downstream of the sampling inlet 14. If the analysis of the first portion of the sample indicates that a substance of interest may be present in the sample, then a SERS analysis is performed on the material deposited on the SERS surface 18. If the SERS analysis indicates that no substance of interest is present in the sample, then a false alarm is output which indicates that the output from the detector 100 was a false positive (e.g. that there was another substance with similar properties to the substance of interest in the sample, but which was not the substance of interest). If the SERS analysis indicates that a substance of interest is present in the sample, and it is the same substance as indicated by the detector 100, then an alert is output to indicate that a substance of interest is present in the sample. The heater 19 may be used to heat the SERS surface 18 to remove any sample thereon (e.g. each time a new surface is to be provided onto the SERS surface 18).

However, it will be appreciated in the context of the present disclosure that this sequential ordering need not be performed. For example, detection data may be obtained from both the SERS analyser and the detector 100 for each sample. The controller may determine whether or not the substance of interest is present based on both data streams for each sample.

As will be appreciated in the context of the present disclosure, the detector 100 may be provided by a number of different forms of detector. Examples include any suitable spectrometer, such as a mass spectrometer, or an IMS (to name a few). Reference will now be made to FIG. 2 which shows one example of a detector which may be used as described above.

FIG. 2 is an illustration of a part section through a detector in the form of an ion mobility spectrometer (‘IMS’) 280.

The ion mobility spectrometer 280 illustrated in FIG. 2 includes an ioniser 288 that is separated from a drift chamber 292 by a gate 282. The gate 282 can control passage of ions from the ioniser 288 into the drift chamber 292. As illustrated, the IMS 280 includes an inlet 281 for enabling material to be introduced from the sample of interest to the ioniser 288 (e.g. via the inlet passage opening).

In the example illustrated in FIG. 2, the drift chamber 292 lies between the ioniser 288 and a detector 287, so that ions can reach the detector 287 by traversing the drift chamber 292. The drift chamber 292 may comprise a series of drift electrodes 283, 284 for applying a voltage profile along the drift chamber 292 to move ions from the ioniser 288 along the drift chamber 292 toward the detector 287.

The IMS 280 may be configured to provide a flow of drift gas in a direction generally opposite an ion's path of travel to the detector 287. For example, the drift gas can flow from adjacent the detector 287 toward the gate 282. As illustrated, a drift gas inlet 289 and drift gas outlet 290 can be used to pass drift gas through the drift chamber. Example drift gases include, but are not limited to, nitrogen, helium, air, air that is re-circulated (e.g., air that is cleaned and/or dried) and so forth.

The detector 287 may be coupled to provide a signal to a detection controller 294. Current flow from the detector 287 can be used by the controller 294 to infer that ions have reached the detector 287, and a characteristic of the ions can be determined based on the time for ions to pass from the gate 282 along the drift chamber 292 to the detector 287. Examples of a detector 287 are configured to provide a signal indicating that ions have arrived at the detector 287. For example, the detector may comprise a conductive electrode (such as a Faraday plate).

Electrodes 283, 284 may be arranged to guide ions toward the detector 287, for example the drift electrodes 283, 284 may comprise rings which may be arranged around the drift chamber 292 to focus ions onto the detector 287. Although the example of FIG. 2 includes only two drift electrodes 283, 284, in some examples a plurality of electrodes may be used, or a single electrode may be used in combination with the detector 287 to apply an electric field to guide ions toward the detector 287.

The spectrometer 280 is shown comprising ion modifier electrodes 285, 286 arranged in the drift chamber, although it is to be appreciated in the context of this disclosure that these may not be included.

As shown in FIG. 2 a voltage provider 293 is coupled to be controlled by the controller 294. The voltage provider 293 may also be coupled to provide voltages to the ioniser 288 to enable material from a sample to be ionised. In an embodiment the voltage provider 293 is coupled to the gate electrode 282 to control the passage of ions from the ionisation chamber into the drift chamber 292. The voltage provider 293 can be coupled to the drift electrodes 283, 284 for providing a voltage profile for moving ions from the ioniser 288 toward the detector 287.

As noted above, the drift electrodes 283, 284 may provide a voltage profile that moves ions along the drift chamber so that the ions travel from the ioniser toward the detector. As illustrated in FIG. 2, the first ion modifier electrode 285 and the second ion modifier electrode 286 can be spaced apart in the direction of travel of the ions.

The spectrometer and the voltage provider may be contained in a common housing. In spectrometry ion counts may be measured by peaks on a spectrum, and the height of a peak may be an indicator of the number of ions reaching the detector at a particular time. Ions which are produced by ions which are produced by reactions of the neutral molecules of the substance of interest may be termed “daughter ions”, and ions from which daughter ions are produced may be termed “parent ions”.

As noted above, other types of detector may be used. For example, a mass spectrometer may be used such as a time of flight mass-spectrometer. In such spectrometers ions mass to charge ratio may be inferred from their time of flight through a vacuum. In other types of mass spectrometer, ions maybe separated in other ways based on their mass to charge ratios, for example by deflection under electric or magnetic fields.

A detection apparatus including the detector, the sampling system 10 and the SERS analyser may be provided in a portable unit.

As disclosed herein, detection apparatuses of the present disclosure may use a SERS analyser for performing SERS analysis on a SERS surface. Such a SERS analyser may be configured to provide exciting radiation in typical bands for Raman, for example near-infrared (e.g., 850 nm or 780 nm), visible (e.g., 635 nm or 532 nm) and/or, potentially, UV (e.g., 250 nm) to an active surface of the SERS surface. The SERS analyser may be configured to collect radiation scattered by the SERS surface and analyse this scattered radiation to provide spectroscopic data corresponding to a Raman signature of the sample (e.g. the sample provided on the SERS surface). This spectroscopic data may be provided to a controller which may store and/or process the data or provide this data for communication to a further device.

Surface-Enhanced Raman spectroscopy or surface-enhanced Raman scattering (SERS) is a surface-sensitive technique that enhances Raman scattering by molecules adsorbed on suitably decorated surfaces with nanostructures such as plasmonic nanoparticles. For example, one method for performing SERS measurements is by depositing a sample onto a silicon or glass surface with nanostructured noble metal inclusions. Surfaces are often prepared using a distribution of metal nanoparticles on the surface. The most commonly used metals for visible light SERS are silver and gold. The use of aluminium has also been proposed for UV SERS. To reduce cost, SERS active particles may be provided on a substrate-for example nanoparticles may be provided on a substrate so that SERS can be performed on a sample on that substrate. The SERS surfaces of the present disclosure may be decorated with gold nanoparticles, possibly in regular arrangements. The SERS surfaces may be selected to have reduced, or no, background fluorescence at the wavelength chosen for SERS analysis (such as 850 nm, 780 nm, 633 nm, 532 nm or 400 nm). Example SERS surfaces include paper-based and/or other cellulose-based substrates decorated with gold or silver nanoparticles. Other examples include membrane-based substrates decorated with gold or silver nanoparticles (such as substrates commonly used in gas filters such as PTFE, and/or micro/nano-porous glass, etc.). Other examples also include (all of which may be decorated with gold or silver nanoparticles): cloth-based substrates, such as carbon cloth, graphene or graphite sheets, and/or silicone or semiconductor structures.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates.

For example, any controller (and any of the activities and apparatus outlined herein) may be implemented with fixed logic, such as assemblies of logic gates or programmable logic such as software and/or computer program instructions executed by a processor. The controller may comprise a central processing unit (CPU) and associated memory, connected to a graphics processing unit (GPU) and its associated memory. Other kinds of programmable logic include programmable processors, programmable digital logic (e.g., a field programmable gate array (FPGA), a tensor processing unit (TPU), an erasable programmable read only memory (EPROM), an electrically erasable programmable read only memory (EEPROM), an application specific integrated circuit (ASIC), or any other kind of digital logic, software, code, electronic instructions, flash memory, optical disks, CD-ROMs, DVD ROMs, magnetic or optical cards, other types of machine-readable mediums suitable for storing electronic instructions, or any suitable combination thereof. Such data storage media may also provide a data store of the controller (and any of the apparatus outlined herein).

Other examples and variations of the disclosure will be apparent to the skilled addressee in the context of the present disclosure.

1. A sampling system for a detection apparatus, the detection apparatus comprising: (i) an ion analyser having an ioniser, and (ii) an optical analyser for detecting substances of interest on a sample receiving surface, the sampling system comprising:
a detector inlet for obtaining a volume of air to be sampled;
an ion analyser sampling inlet arranged in the detector inlet to take a first sample from the volume of air in the detector inlet and to provide the first sample to the ioniser; and
a sample receiving surface arranged in the detector inlet to receive a second sample from the volume of air in the detector inlet for optical analysis thereof.

2. The sampling system of claim 1, wherein the optical analyser is a surface-enhanced Raman spectroscopy, SERS, analyser for detecting substances of interest on a SERS-active sample receiving surface; and
wherein the sample receiving surface of the sampling system is a SERS-active surface arranged to receive the second sample for SERS analysis thereof.

3. The sampling system of any preceding claim, wherein the sample receiving surface is arranged downstream of the ion analyser sampling inlet in the direction of air flow through the detector inlet.

4. The sampling system of any preceding claim, wherein the sample receiving surface is arranged so that the air flow through the detector inlet strikes the sample receiving surface, optionally thereby to deposit the second sample on the sample receiving surface.

5. The sampling system of claim 4, wherein the sample receiving surface is arranged across the direction of air flow through the detector inlet.

6. The sampling system of claim 4 or 5, wherein the system is arranged so that air flowing through the detector inlet is forced through the sample receiving surface to deposit the second sample on the sample receiving surface.

7. The sampling system of any preceding claim, wherein a portion of the detector inlet is arranged to enable optical measurements to be obtained from the sample receiving surface.

8. The sampling system of claim 7, wherein said portion of the detector inlet is arranged to provide one or more light sources and/or one or more optical detectors with optical access to the sample receiving surface.

9. The sampling system of claim 7 or 8, wherein said portion of the detector inlet comprises one or more apertures in the detector inlet.

10. The sampling system of any preceding claim, wherein the system comprises a heater for heating the sample receiving surface, optionally wherein the heater is operable to drive off accumulated material from the sample receiving surface.

11. The sampling system of any preceding claim, wherein the ion analyser sampling inlet comprises a pinhole inlet.

12. The sampling system of any preceding claim, wherein the sampling system is for an ion analyser comprising an ion mobility spectrometer, IMS, or a mass spectrometer, MS.

13. A detection apparatus for detecting substances of interest, the apparatus comprising:
the sampling system of any preceding claim;
an ion analyser having an ioniser, wherein the ion analyser is coupled to the sampling system and arranged to identify the presence of one or more substances of interest in the first sample provided to the ion analyser through the ion analyser sampling inlet of the sampling system; and
an optical analyser coupled to the sampling system and arranged to identify the presence of one or more substances of interest in the second sample received by the sample receiving surface of the sampling system.

14. The detection apparatus of claim 13, wherein the ion analyser comprises an IMS or an MS.

15. The detection apparatus of claim 13 or 14, wherein the apparatus is arranged so that the first and second sample are provided from the same volume of air flowing through the detector inlet of the sampling system.

16. The detection apparatus of any of claims 13 to 15, wherein the apparatus is configured to selectively control operation of: (i) the optical analyser based on operation of the ion analyser, or (ii) the ion analyser based on operation of the optical analyser.

17. The detection apparatus of any of claims 13 to 16, wherein the apparatus is configured to determine that a substance of interest is present in the air from the detector inlet of the sampling system based on analysis performed by both the ion analyser and the optical analyser.

18. The detection apparatus of claim 17, wherein the apparatus is configured to identify that the substance of interest is present in the air from the detector inlet of the sampling system in the event that both: (i) the analysis performed by the ion analyser, and (ii) the analysis performed by the optical analyser, indicate that the substance of interest is present.

19. The detection apparatus of claim 17 or 18, wherein the apparatus is configured to determine that the substance of interest is not present in the event that at least one of: (i) the analysis performed by the ion analyser, and (ii) the analysis performed by the optical analyser, indicates that the substance of interest is not present.

20. The detection apparatus of any of claims 13 to 19, wherein at least one of:
the apparatus is configured to control operation of the ion analyser to identify the presence of one or more substances of interest in the first sample, and in the event that a substance of interest is identified in the first sample using the ion analyser, the apparatus is configured to control operation of the optical analyser to identify the presence of that substance of interest in the second sample; and
the apparatus is configured to control operation of the optical analyser to identify the presence of one or more substances of interest in the second sample, and in the event that a substance of interest is identified in the second sample using the optical analyser, the apparatus is configured to control operation of the ion analyser to identify the presence of that substance of interest in the first sample.

21. The detection apparatus of any of claims 13 to 20, wherein the apparatus is hand-held, optionally wherein the apparatus is battery powered.

22. A method of controlling operation of a sampling system for a detection apparatus, the detection apparatus comprising: (i) an ion analyser having an ioniser, and (ii) an optical analyser for detecting substances of interest on a sample receiving surface, wherein the method comprises:
flowing air through a detector inlet of the sampling system;
taking a first sample from the detector inlet and providing said first sample to an ioniser of an ion analyser; and
receiving a second sample from the detector inlet on a sample receiving surface in the detector inlet.

23. A method of controlling operation of a detection apparatus to identify the presence of one or more substances of interest in a volume of air flowing through a detector inlet of a sampling system of the detection apparatus, the method comprising at least one of:
operating an ion analyser to identify the presence of one or more substances of interest in a first sample taken from the detector inlet, and in the event that the ion analyser identifies the presence of one or more substances of interest in the first sample, operating an optical analyser to identify the presence of said one or more substances of interest in a second sample received on a sample receiving surface in the detector inlet; and
operating an optical analyser to identify the presence of one or more substances of interest in a second sample received on a sample receiving surface in the detector inlet, and in the event that the optical analyser identifies the presence of one or more substances of interest in the second sample, operating an ion analyser to identify the presence of said one or more substances of interest in a first sample taken from the detector inlet.

24. A method of detecting the presence of a substance of interest in a volume of air flowing through a detector inlet of a sampling system, the method comprising:
determining whether a first substance of interest is present in a first sample taken from the detector inlet based on ion analyser data from ion analysis of the first sample;
determining whether the first substance of interest is present in a second sample received on a sample receiving surface in the detector inlet based on optical analyser data from optical analysis of the second sample; and
indicating that the first substance of interest is present in the event that it is determined that the first substance of interest is present in both the ion analyser data and the optical analyser data.

25. A computer program product comprising computer program instructions configured to program a controller to control operation of a device to perform the method of any of claims 22 to 24.
